(19) United States
(12) Patent Application Publication
(10) Pub. No.: US 2008/0316003 A1
(43) Pub. Date: Dec. 25, 2008

(54) ELECTRIC LOAD CONTROL SYSTEM HAVING REGIONAL RECEIVERS

(76) Inventors: Thomas Alan Barnett, Ypsilanti, MI (US); Jeffrey Joseph Iott, Monroe, MI (US); John Gerard Finch, Livonia, MI (US)

Correspondence Address: Masco Corporation, 21001 Van Born Road, Taylor, MI, 48480, US

(21) Appl. No.: 11/765,469

(22) Filed: Jun. 20, 2007

(51) Int. Cl. G05B 11/01

(52) U.S. Cl. 340/310.11

(57) ABSTRACT

A lighting control circuit is provided with a plurality of wireless controls. Each of the wireless controls receives wireless signals from at least one switch, and processes those signals to control components in at least a plurality of rooms. In addition, the controls are operable to dim at least one component supplied with power by the control.

### BACKGROUND OF THE INVENTION

This application relates to an electric load control system for supplying electric power to various components such as lights, receptacles, fans, etc. A wireless multi-channel receiver receives wireless signals from switches, and processes those signals to control various components. There are local receivers spaced within the building, and controlling components in at least several rooms.

Electrical control systems are known, which include a multi-channel receiver. The multi-channel receiver receives signals from a plurality of wireless switches, and processes those signals to control power to various components such as lights, or electrical receptacles. These systems have benefits over the prior art, in that wire is not required to run between the switches and a controller, as has historically been the case.

For the most part, these systems have included a single main receiver for an entire building. A single receiver receives signals from a plurality of switches, and controls various components throughout a building. Electric power wires must run from the receiver to each of the components. Since there has been a single receiver, some of the electrical power lines have run for great distances.

In one system, which has been utilized in a large office complex, there are separate wireless receivers for each of a plurality of offices. Thus, each of the offices is provided with a single receiver that receives wireless signals from a switch, and then processes those signals to control components within that room. While the distance that power lines must run from the receiver to the components is reduced, each of the receivers must receive a power supply from an electrical power source. Thus, the use of so many receivers somewhat defeats the purpose of having plural receivers. Moreover, these proposed systems have not been provided with a dimmer circuit.

### SUMMARY OF THE INVENTION

In a disclosed embodiment of this invention, a plurality of receivers are spaced within a building. Each of the receivers includes a plurality of channels for controlling a plurality of components. Wireless signals are sent from switches to the receiver, and the receiver processes those signals to control various components such as a light, or an electrical receptacle. In addition, for some electrical receptacles, electric power may be supplied constantly, with no control. The receivers control components in a plurality of rooms. Thus, there are fewer receivers, and fewer power lines need to be supplied.

In addition, the receivers are able to dim the intensity of components, such as a light.

These and other features of the present invention can be best understood from the following specification and drawings, the following of which is a brief description.

### BRIEF DESCRIPTION OF THE DRAWINGS

FIG. 1 is a schematic view of a lighting control system.

FIG. 2 is a dimmer circuit, which may be incorporated into the FIG. 1 system.

FIG. 3 shows the use of a plurality of the FIG. 1 systems spaced across a building.

### DETAILED DESCRIPTION OF THE PREFERRED EMBODIMENT

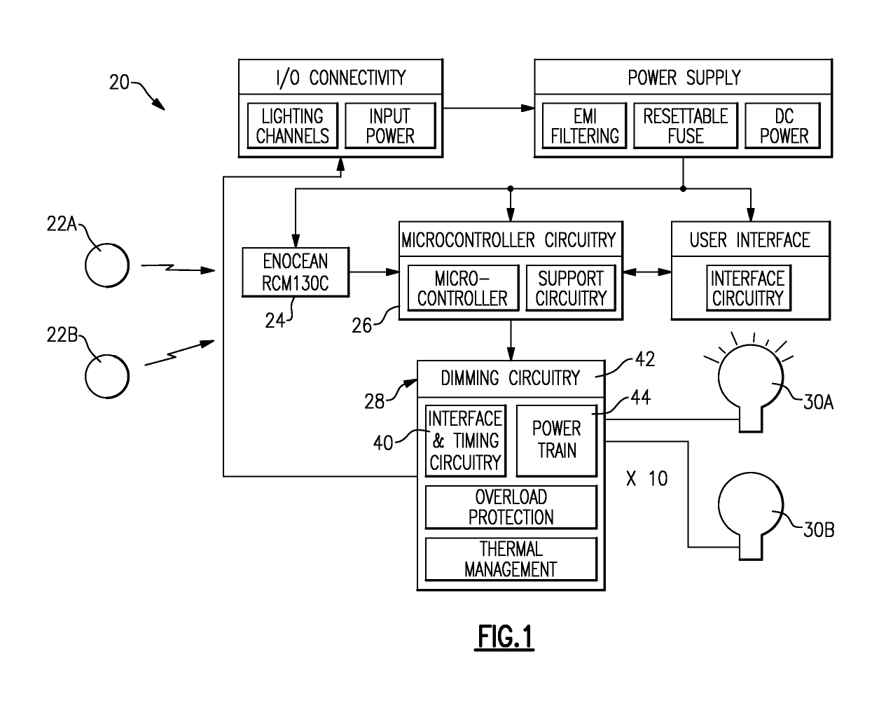

FIG. 1 shows a load control circuit 20 for a building. A plurality of dimmer switches 22A, 22B communicate through a wireless connection to a multi-channel receiver 24. The receiver 24 in one example comprises a commercially available component. One example is available from Enocean under its Product No. RCM130C. The type of wireless receiver and wireless switches are not limiting on this invention, but only mentioned as one possible type of system. The wireless connection between the switches 22 and the receiver 24 allows for the switches to be located remotely from the receiver 24. For example, the receiver 24 may be supported at or near an electrical outlet in a selected room and the switches may be positioned at any convenient other location within or near the room.

The receiver 24 communicates with a microcontroller 26, which in turn communicates with dimmer circuit 28. The dimmer circuit 28 controls the intensity of several lights 30A, 30B. The illustrated dimmer circuit 28 includes timing circuitry 40, a dimmer portion 42 and a power train portion 44. The illustrated example also includes an overload protection portion and a thermal management portion.

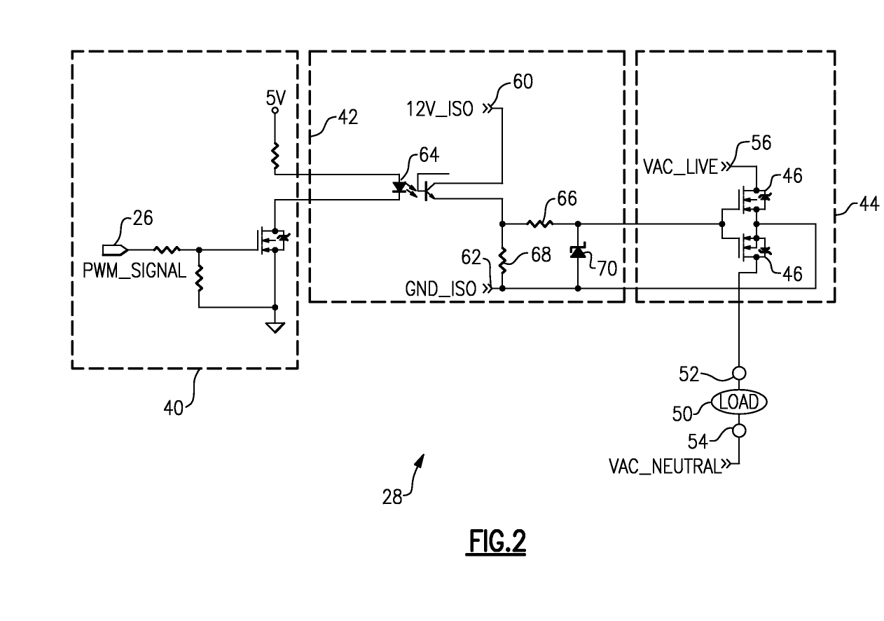

One example embodiment of the dimmer circuit 28 is illustrated in FIG. 2. The microcontroller 28 provides a timing control signal input to the timing portion 40. The timing control signal in one example comprises a pulse width modulation control signal. The timing control signal controls when the dimming portion 42 activates the MOSFET switches 46 of the power train portion 44 to control the amount of power supplied to a load 50. The microcontroller 26 determines how to set the timing control signal based upon what setting a user selects (e.g., what dimming level is desired). In one example, the microcontroller 26 uses known techniques for providing the pulse width modulation input to achieve a desired corresponding amount of dimming.

One example load 50 is a light bulb. Controlling the light intensity of a bulb is one example use of the illustrated arrangement. In this example, the load 50 is plugged into a wall socket having terminals schematically represented at 52 and 54

The MOSFETs 46 in one example operate according to a known reverse phase control strategy when the gate and source of each is coupled with a sufficient voltage to set the MOSFETs 46 into an operative state (e.g., turn them on) so that they allow power from a source 56 (e.g., line AC) to be supplied to the load 50. In the reverse phase control example, the MOSFETs 46 are turned on at 0 volts and turned off at a high voltage. In another example a forward phase control strategy is used where the MOSFETs 46 turn on at a high voltage and off at 0 volts. Another example includes turning the MOSFETs 46 on at a non-zero voltage and turning them off at another non-zero voltage.

The dimming portion 42 controls when the power train portion 44 is on and, therefore, controls the amount of power provided to the load 50. Controlling the amount of power provided to a light bulb controls the intensity of light emitted by the bulb, for example.

In this example, an isolated DC voltage source 60 is selectively coupled directly to the gate and source of the MOSFETs 46 for setting them to conduct for delivering power to the load. The isolated DC voltage source 60 has an associated floating ground 62. A switch 64 responds to the timing control signal input from the microcontroller 26 and enters an operative state (e.g., turns on) to couple the isolated DC voltage source 60 to the MOSFETs 46. In the illustrated example, the switch 64 comprises an opto-coupler component. Other examples include a relay switch or a transformer component for selectively coupling the isolated DC voltage source 60 to the MOSFETs 46.

In one example, the isolated DC voltage source 60 provides 12 volts. In another example, a lower voltage is used. The voltage of the isolated DC voltage source 60 is selected to be sufficient to turn on the MOSFETs 46 to the saturation region.

One example includes using an isolated DC-DC converter to achieve the isolated DC voltage source 60. Another example includes a second-stage transformer. Those skilled in the art who have the benefit of this description will realize what components will work best for including an isolated DC voltage source in their particular embodiment.

The illustrated example includes voltage controlling components for controlling the voltage that reaches the gate and source of the MOSFETs 46. The illustrated example includes resistors 66 and 68 and a zener diode 70. The resistor 66 sets the turn on speed or the time it takes to turn on the MOSFETs 46. The resistors 66 and 68 set the turn off speed or the time it takes to turn off the MOSFETs 46. In one example, the resistor 68 has a much higher resistance compared to that of the resistor 66 such that the resistor 68 effectively sets the turn off time for the MOSFETs 46. Selecting an off speed and on speed allows for avoiding oscillation of the MOSFETs 46 and avoiding generating heat if the MOSFETs 46 were to stay in a linear operation region too long.

The zener diode 70 provides over voltage protection to shield the MOSFETs from voltage spikes and noise, for example. The zener diode 70 is configured to maintain the voltage provided to the MOSFET gate and source inputs at or below the diode's reverse breakdown voltage in a known manner. One example does not include a zener diode.

One advantage to the disclosed example is that the MOSFETs can be fully controlled during an entire AC cycle without requiring a rectifier. The disclosed example is a more efficient circuit arrangement compared to others that relied upon RC circuitry and a rectifier for controlling the MOSFETs.

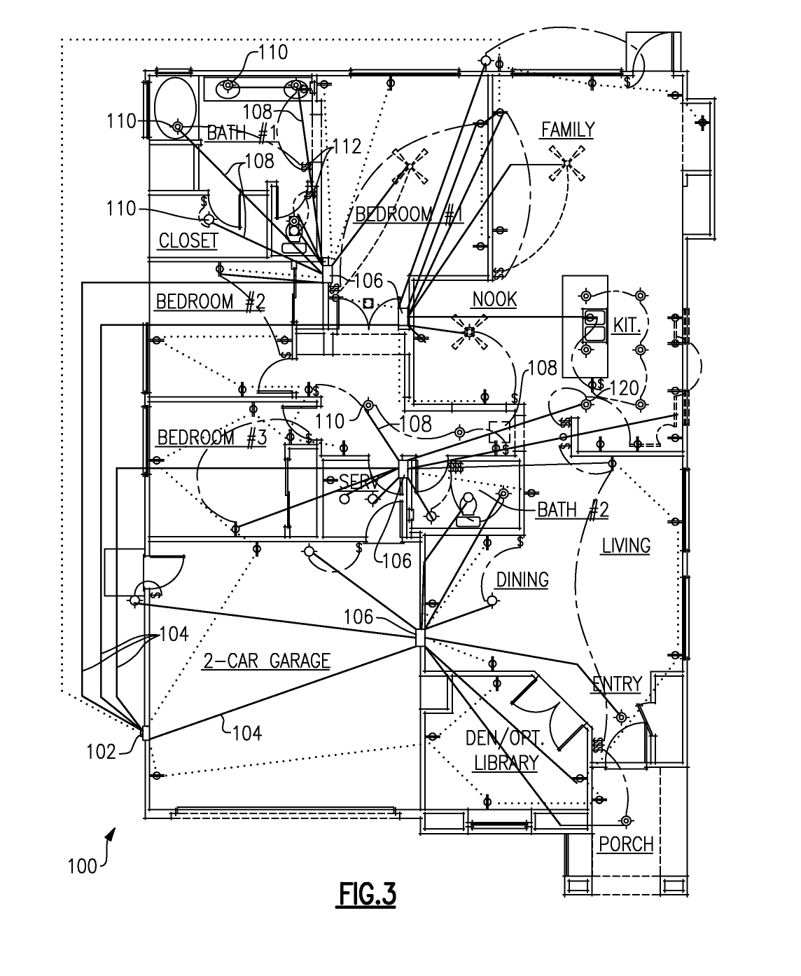

FIG. 3 shows a residential building 100 incorporating a plurality of the receivers/microprocessors as set forth in FIG. 1. As shown, an electrical power source 102, such as a circuit breaker box, supplies power through a plurality of power lines 104 to a plurality of receivers/microprocessors 106. Essentially, each receiver/microprocessor 106 may be similar to the control as set forth in claim 1. Each of the receivers/microprocessors 106 are shown to have power lines 108 communicating with various components 110, which may be electrical receptacles, lights, fans, or other components. Lights and receptacles may be associated with a dimmer circuit, if it is desirable to dim the light, or a component plugged into the receptacle.

As can be seen, the receivers/microprocessor 106 control components 110 in a plurality of rooms. As such, fewer receivers/microprocessor are necessary than would be the case if each room had its own. This reduces the number of power lines 104, which must travel to each receiver/microprocessor.

As shown, the receivers/microprocessors 106 receive wireless signals from switches 1 12. Again, the technology for providing a wireless signal from a switch 112 to the receiver/microprocessor 106 is generally as known. However, the use of local receivers/microprocessor for controlling components in a plurality of rooms is novel. Moreover, the use of dimming circuitry into the arrangement such as shown in FIG. 3, wherein there are local receivers, is also novel.

While the receivers/microprocessors 106 are shown directly connected by electrical supply lines to the various components that are controlled, more recent developments which include the supply of wireless power to the components would also come within the scope of this invention. That is, the receivers/microprocessors 106, receive wireless signals from switches, and are specifically disclosed as delivering power to the components over electric lines, but that power supply can also be wireless.

While an embodiment of this invention has been disclosed, a worker of ordinary skill in this art would recognize that certain modifications would come within the scope of this invention. For that reason, the following claims should be studied to determine the true scope and content of this invention.

What is claimed is:

1. A load control circuit for a building comprising:
a plurality of controls, said controls each receiving signals from at least one wireless switch; and
a plurality of electrical components supplied with electrical power from said controls, said plurality of components controlled by at least one of said controls to be in at least two different rooms within a building.

2. The load control circuit as set forth in claim 1, wherein said controls are operable to dim at least one component that receives power from said controls.

3. The load control circuit as set forth in claim 1, wherein each of said plurality of controls receives a power supply line from an electric power supply.

4. The load control circuit as set forth in claim 1, wherein the building is a residential building.

5. The load control circuit as set forth in claim 1, wherein said controls include a multi-channel receiver and an associated microprocessor.

6. The load control circuit as set forth in claim 1, wherein said controls communicate electrical power to said electrical components with a hard supply wire.

7. The load control circuit as set forth in claim 1, wherein said control communicates electrical power to said electrical components with a wireless connection.

8. A load control circuit for a building comprising:
a plurality of controls, said controls receiving signals from at least one wireless switch;
a plurality of electrical components supplied with electrical power from said control; and
said control operable to dim at least one component that receives power from said wireless control.

9. The load control circuit as set forth in claim 8, wherein each of said plurality of controls receives a power supply line from an electric power supply.

10. The load control circuit as set forth in claim 8, wherein said controls communicate electrical power to said electrical components with a hard supply wire.

11. The load control circuit as set forth in claim 8, wherein said control communicates electrical power to said electrical components with a wireless connection.

12. A building comprising:
a plurality of rooms;
a plurality of controls, said controls being operable to receive a wireless signal from at least one switch, said controls being operable to supply electric power to components located in at least two of said plurality of rooms.

13. The building as set forth in claim 12, wherein said controls are operable to dim at least one component that receives power from said control.

14. The building as set forth in claim 12, wherein each of said plurality of controls receives a power supply line from an electric power supply.

15. The building as set forth in claim 12, wherein the building is a residential building.

16. The building as set forth in claim 12, wherein said controls communicate electrical power to said electrical components with a hard supply wire.

17. The building as set forth in claim 12, wherein said control communicates electrical power to said electrical components with a wireless connection.
